(19) United States
(12) Patent Application Publication
(10) Pub. No.: US 2002/0052831 A1
(43) Pub. Date: May 2, 2002

(54) Method of consumer cash flow transfer via purchase and sale agreement

(76) Inventor: Paul Robert Levy, Palm Bay, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 09/999,386

(22) Filed: Oct. 31, 2001

Related U.S. Application Data
(60) Provisional application No. 60/244,741, filed on Oct. 31, 2000.

(51) Int. Cl. G06F 17/60

(52) U.S. Cl. 705/37

(57) ABSTRACT

A method for providing loans to high-risk consumers at a rate which is within statutory limits while providing a net return to lenders which justifies the loan. In one form, the consumer enters into a purchase and sale agreement with the lender in which the lender purchases goods from the consumer so as to obtain title and then re-sells the goods to the consumer on an installment contract. The lender may purchase the goods at a percentage of wholesale value of the goods and re-sell the goods at a percentage of retail value. The consumer receives cash from the sale and re-purchases the goods over time thereby resolving the consumer's short-term cash flow issue.

This application claims the benefit of the Oct. 31, 2000 filing date of United States provisional patent application serial No. 60/244,741.

The present invention relates to collateral based loan transactions and, more particularly, to a method for providing short-term cash flow to a high-risk consumer using consumer collateral without entering into a prohibited high interest loan agreement.

The term “high risk consumer” is used herein to refer to a consumer for which there is a substantially high probability that the consumer will default on a loan.

Conventional lending sources, such as banks, finance companies and savings and loan organizations generally deny loans, particularly low dollar loans to high risk consumers. As a consequence, one of the primary sources of loans for such consumers has been through pawning of various household items. More recently, other entities have been created in order to provide higher value loans to such consumers based upon more valuable items, such as automobiles. Because of the manner in which these entities operate, they have become recognized under the general rubric of “title loan” companies.

Title loan companies differ from traditional pawning by allowing the consumer to maintain possession of the “pawned” item. Using automotive vehicles as an example, the title loan companies require the consumer to sign over the title to a vehicle and then hold the title as collateral for the loan while allowing the consumer to hold and use the vehicle.

Because there is a high risk associated with repayment of these loans and because the loans are normally for relatively small amounts, the apparent interest rate on the loans can often be as high as 200 per cent. In many states, the legislature has placed restrictions on title loans limited the maximum rate that can be charged. The restrictions have made the loans unprofitable for small amounts and have essentially eliminated the availability of such loans to the high-risk consumer. However, there still exists a demand for such low value, short-term loans to high-risk consumers.

### SUMMARY OF THE INVENTION

The present invention is directed to a method for providing short-term cash flow to consumers. In particular, the method is directed to consumers who have collateral in the form of vehicles or other titled goods and have short-term cash flow issues but to whom conventional lending institutions are not willing to lend money. In the present method, the consumer is provided with the ability to resolve a cash flow problem by selling titled goods, including vehicles, to a licensed dealer of such goods for a negotiated price so that the consumer is provided with an immediate influx of cash. As part of a vehicle transaction, the dealer and consumer agree that the dealer will sell the vehicle back to the consumer and the consumer will purchase the vehicle at another price. In a preferred method, the dealer and consumer enter into a vehicle purchase and sale agreement allowing the consumer to purchase the goods on a time payment plan. In the case of a vehicle, the dealer may agree to purchase the vehicle for cash from the consumer based upon the then current Black Book wholesale price in one transaction and to sell the vehicle back to the consumer based upon the then current Black Book retail price in a second transaction. The “Black Book” is a published manual of vehicle sales values and is used by licensed dealers to determine wholesale, retail and trade-in values for vehicles. The consumer can then elect to pay for the vehicle on an installment plan at conventional loan rate. Depending upon the consumer's cash flow needs at the time of the transaction, the amount of the net debt owed by the consumer can be adjusted by prepayment or by agreeing to lower purchase and sale values.

### BRIEF DESCRIPTION OF THE DRAWINGS

FIG. 1 is a simplified flow diagram of one form of the present invention.

### DETAILED DESCRIPTION OF THE INVENTION

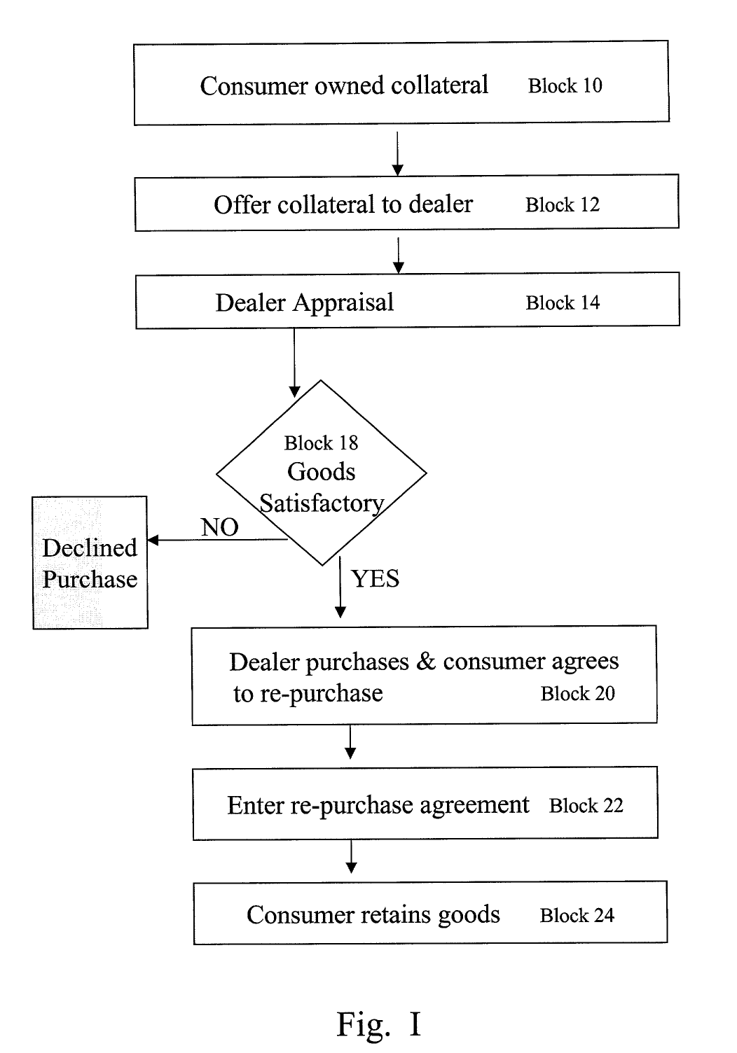

FIG. 1 is a generalized flow chart showing one form of implementation of the present invention in a consumer transaction. As shown, the consumer holds title to an item of valuable goods, such as a vehicle, block 10. The consumer approaches a licensed dealer in such goods, block 12, and offers to sell the goods to the dealer. The dealer will evaluate the goods, block 14, and, if the goods meet the dealers' requirements, block 16, will offer to purchase the goods from the consumer for cash, block 18. As a part of the sales transaction, the dealer agrees to sell the goods, such as a vehicle, back to the consumer on a conventional installment payment plan at a conventional interest rate, block 20. The consumer then enters into an installment purchase agreement with the dealer, block 22. The consumer takes possession of the goods subject to the installment agreement, block 24. This allows the consumer to obtain possession of the goods and to also have the cash to solve the consumer's short-term cash flow problem.

In the particular case of the goods comprising a vehicle, the dealer is a licensed dealer in vehicles and may offer to purchase the vehicle from the consumer at some percentage of the then current Black Book wholesale value, subject to any deductions for wear and tear unique to the vehicle. If the vehicle is subject to an existing lien and the value of the vehicle exceeds the lien value, the dealer may still purchase the vehicle and obtain title by paying off the existing lien and paying the difference to the consumer in cash. The consumer then enters into a new installment contract with the dealer to purchase the vehicle at a new negotiated price, such as a percentage of the then current Black Book average retail value. By way of example, the dealer may purchase the vehicle for no less than one-third the Black Book wholesale value and re-sell the vehicle to the consumer for no less that one-third the Black Book retail value.

The present invention thus provides a mechanism for a consumer to obtain cash to resolve short-term cash flow problems while maintaining possession of valuable goods, such as a vehicle.

What is claimed is:

1. A method for enabling a consumer to obtain cash from consumer goods without giving up possession of the goods comprising:
entering into a sales transaction with a dealer of the goods wherein the dealer agrees to purchase the goods from the consumer for cash payment; and
concurrently executing an installment purchase agreement wherein the dealer agrees to sell the same goods to the consumer.

2. The method of claim 1 wherein the dealer purchases the goods from the consumer at a first price and sells the goods to the consumer at a second price greater than the first price.

3. The method of claim 2 wherein the first price is a wholesale price and the second price is a retail price.

4. The method of claim 3 wherein the goods comprise a vehicle.

5. The method of claim 4 wherein the wholesale price is a percentage of the price set in the then current addition of the Black Book as the wholesale price.

6. The method of claim 4 wherein the retail price is a percentage of the retail price set in the then current addition of the Black Book.

7. The method of claim 2 wherein the installment purchase agreement includes an interest rate.

8. The method of claim 7 wherein the interest rate is within the range of consumer interest rates allowed by statute.

9. The method of claim 2 wherein the first price is no less than one-third of the then current wholesale value of the vehicle.

10. The method of claim 9 wherein the wholesale value is determined from the Black Book listing.

11. The method of claim 2 wherein the second price is no less than one-third of the retail value of the vehicle.

12. The method of claim 11 wherein the retail value is determined from the Black Book listing.
